(19) United States
(12) Patent Application Publication
(10) Pub. No.: US 2024/0268424 A1
(43) Pub. Date: Aug. 15, 2024

(54) System and Method for Making Egg Products Utilizing Cooked Egg

(71) Applicant: IsoNova Technologies, LLC, Springfield, MO (US)

(72) Inventors: Joel Bartley, Florissant, MO (US); Sivakumar Raghavan, Saint Peters, MO (US); Gary R Copeland, Granby, MO (US); Ingomar S Middelbos, Chesterfield, MO (US); Jennifer Henrickson, Kalamazoo, MI (US)

(21) Appl. No.: 18/438,416

(22) Filed: Feb. 10, 2024

Related U.S. Application Data
(60) Provisional application No. 63/484,464, filed on Feb. 10, 2023.

(51) Int. Cl. A23L 15/00; A23B 5/02; A23P 10/20; A23P 10/40

(52) U.S. Cl. CPC A23L 15/00; A23B 5/02; A23P 10/20; A23P 10/40

(57) ABSTRACT

A method of making dried egg product utilizing cooked eggs includes a mixing step, a drying step, and at least one transporting step. In the mixing step, an amount of cooked eggs is mixed with an amount of liquid egg to create a mixture. In the drying step, at least one item selected from the group consisting of the mixture and a homogeneous mixture created from the mixture are dried to create the dried egg product. In the at least one transporting step, the mixture is transported from the mixing step to the drying step. The mixture is less viscous than the amount of cooked eggs to facilitate transporting from the mixing step to the drying step. The mixture is not processed through a filter or membrane for removing water.

### CROSS-REFERENCE TO RELATED APPLICATIONS

This application claims the benefit of priority of U.S. Provisional Patent Application No. 63/484,464, filed Feb. 10, 2023, the disclosure of which is incorporated by reference herein in its entirety.

### FIELD OF INVENTION

The disclosure relates generally to methods of making dried egg products. More specifically, the disclosure relates to methods and systems for using cooked egg, such as hard-boiled eggs, to make dried egg products.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

According to an embodiment of the current disclosure, a method of making dried egg product utilizing cooked eggs includes the steps of selecting an amount of cooked eggs and an amount of liquid egg, creating a mixture, transporting the mixture, and drying. The mixture includes the amount of cooked eggs and the amount of liquid egg and is less viscous than the amount of cooked eggs. The drying step includes drying at least one item selected from the group consisting of the mixture and a homogeneous mixture created from the mixture to create the dried egg product. The amount of cooked eggs and the amount of liquid egg are selected based on: (a) a desired solid and protein level in the dried egg product; and/or (b) a desired viscosity of the mixture; and/or (c) the amount of ash in the dried egg product. The amount of cooked eggs and the amount of liquid egg make up at least 95% by weight of the mixture. Systems for implementing this method are disclosed herein.

According to another embodiment of the current disclosure, a method of making dried egg product utilizing cooked eggs includes a mixing step, a drying step, and at least one transporting step. In the mixing step, an amount of cooked eggs is mixed with an amount of liquid egg to create a mixture. In the drying step, at least one item selected from the group consisting of the mixture and a homogeneous mixture created from the mixture are dried to create the dried egg product. In the at least one transporting step, the mixture is transported from the mixing step to the drying step. The mixture is less viscous than the amount of cooked eggs to facilitate transporting from the mixing step to the drying step. The mixture is not processed through a filter or membrane for removing water. Systems for implementing this method are disclosed herein.

### BRIEF DESCRIPTION OF THE DRAWINGS

Embodiments of the invention are described in detail below with reference to the attached drawings.

FIG. 1 is a first schematic of an embodiment of a system and method for making egg products utilizing cooked egg, such as hard-boiled eggs.

FIG. 2 is a second schematic of an embodiment of a system and method for making egg products utilizing cooked egg, such as hard-boiled eggs.

The drawings do not limit the invention to the specific embodiments disclosed and described herein. The drawings are not necessarily to scale, emphasis instead being placed upon clearly illustrating various principles of the disclosure.

### DETAILED DESCRIPTION

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Eggs are an important and popular food product and are produced in large quantities in the United States. It is estimated that approximately 50 billion eggs are produced each year in the U.S., most of which are chicken eggs, with many of these eggs coming from high production facilities. In this large number of eggs, some will be deemed inedible. “Inedible” means not suitable for human consumption. An egg is inedible when it is broken, has blood spots, or has other abnormalities for which the USDA has stated cannot be used in human foods. These inedible eggs are conventionally processed into one or more inedible egg products that may be used in animal feed. Edible eggs, on the other hand, are suitable for human consumption.

Conventional processes utilize one or more separation techniques, such as centrifugation, to separate out liquid egg (i.e., inedible liquid egg or edible liquid egg), which can then be pasteurized, dried, and packaged for use.

Another sector of the egg industry produces a large number of cooked (e.g., hard-boiled) eggs with and without shells. Cooked eggs without shells refers to eggs with 0-20% residual shells. It is common for a number of these eggs to have defects, such as being mis-shaped, broken, or damaged. Conventionally, these defective cooked eggs are discarded and sent into landfills, creating food waste. Various embodiments of the present disclosure provide for systems and methods that utilize cooked eggs for making dried egg products (i.e., dried inedible egg products or dried edible egg products), which may increase production and decrease food waste. Systems and methods discussed herein combine cooked egg, such as hard-boiled eggs, with liquid egg (i.e., inedible liquid egg or edible liquid egg) from one or more of broilers, graders, and/or breakers from egg production facilities to produce dried egg products (i.e., dried inedible egg products or dried edible egg products), without a need for using added water in the process.

Embodiments presented herein provide a way to increase the solid content of liquid egg, making it into a slurry or semi-liquid mixture with a viscosity low enough to pump the mixture to a drier and dry it into a final dried egg product. Cooked (e.g., hard-boiled) eggs may be directly used with liquid egg, thereby increasing solids and protein levels of a resulting mixture, and also avoiding the addition of extra water which would require some form of subsequent water separation, such as use of one or more membranes or evaporation techniques.

In certain embodiments, a method is disclosed for making dried egg product utilizing cooked eggs, comprising:
(a) selecting an amount of cooked eggs and an amount of liquid egg;
(b) creating a mixture comprising the amount of cooked eggs and the amount of liquid egg;
(c) drying said mixture to create the dried egg product.

The term “egg” refers to any bird egg, preferably poultry eggs. The egg products can be a mixture of egg white (albumen) and egg yolk. In certain embodiments, the egg products can be egg white only or egg yolk only, even if these embodiments are not the preferred ones in the present invention.

The liquid egg is the liquid material from eggs that have been cracked open or pressed to remove the liquid, and which may or may not have been processed (e.g. pasteurized). Liquid egg does not contain any shells. Liquid egg may be obtained from any source as would be understood by those skilled in the art, such as breakers, broilers, or graders.

Liquid egg can contain egg yolk, alone or in mixture with egg white. Liquid egg may contain more than 0.2%, or more than 0.3%, or more than 0.5%, or more than 1%, or more than 2%, or more than 5%, or more than 10%, or more than 20%, or more than 30% or more than 40% egg yolk by weight of total solids. Liquid egg may contain less than 70%, or less than 60%, or less than 55%, or less than 50%, or less than 45% egg yolk by weight of total solids.

Liquid egg can contain egg white, alone or in mixture with egg yolk. Liquid egg may contain more than 45%, or more than 50%, or more than 60%, or more than 70%, or more than 80%, or more than 90% egg white by weight of total solids. Liquid egg may contain less than 99.5%, or less than 99%, or less 98%, or less than 97%, or less than 96%, or less than 95%, or less than 90%, or less than 80%, or less than 70% egg white by weight of total solids.

Liquid egg may contain more than 40%, or more than 45% proteins (% based on total solids). Liquid egg may contain less than 85%, or less than 80% proteins (% based on total solids). Liquid egg may contain 40% to 85%, or 45% to 80% proteins (% based on total solids).

Liquid egg may contain more than 8%, or more than 10%, or more than 15% fats (% based on total solids). Liquid egg may contain less than 40%, or less than 35% fats (% based on total solids).

“Cooked eggs” as used herein includes hard-boiled eggs, obtained by cooking eggs in boiling water. Cooked eggs may have residual shell. This can be critical in that it can increase the amount of ash in the dried egg product (which must not exceed 6% on dry basis). Advantageously, cooked eggs contain from 0 to 20 wt %, or from 5 to 20 wt %, or from 5 to 15 wt %, or from 5 to 10 wt % of shell.

While various compositions of cooked eggs may be utilized, it may be advantageous for a solids content of the amount of cooked (e.g., hard-boiled) eggs to be about 27% to about 33%, and for a protein content of the amount of cooked (e.g., hard-boiled) eggs to be about 12% to about 18%.

In one embodiment, cooked eggs, e.g. hard-boiled eggs, are ground via a grinding machine, such as a grinder or a crusher. The grinding machine will be selected by and understood by those skilled in the art and may be any appropriate grinding machine whether now existing or later developed. This grinding step reduces the particle size of cooked eggs.

Step (b) consists of creating a mixture comprising the amount of cooked eggs (either ground or not) and the amount of liquid egg. Step (b) can be performed in a mixing machine, such as a mix tank mixer or a shear mixer.

Advantageously, creating the mixture does not include adding water. Adding the amount of liquid egg decreases the viscosity of the mixture when compared to the cooked eggs, which allows for further processing and transportation of the mixture. The mixture obtained is less viscous than the amount of cooked eggs.

It may be desirable for the amount of cooked (e.g., hard-boiled) eggs and the amount of liquid egg to make up at least 95% by weight of the mixture; and it may be particularly desirable for the amount of cooked (e.g., hard-boiled) eggs and the amount of liquid egg to make up at least 98%, 99%, or 99.9% by weight of the mixture. In some embodiments, the mixture consists essentially of the amount of cooked (e.g., hard-boiled) eggs and the amount of liquid egg, though impurities and additives inconsequential to transporting the mixture may be present.

In one embodiment, the amount of cooked eggs and the amount of liquid egg are selected based on: (a) a desired solid and protein level in the dried egg product; and/or (b) a desired viscosity of the mixture; and/or (c) the amount of ash in the dried egg product (preferably less than 6% on a dry basis). For example, the viscosity of the mixture can be less than 100 cps at 25° C., or between 25 and 100 cps at 25° C.

Some studies have shown that an amount of cooked (e.g., hard-boiled) eggs could be from 10% to 60%, or from 10% to 30%, by weight of the mixture and that an amount of liquid egg could be from 40% to 90%, or from 70% to 90%, by weight of the mixture.

In one advantageous embodiment, the mixture, or a part of the mixture, may be further homogenized. Homogenizing may help prevent clogs in filters and screens used during the process, such as during drying. Homogenizing the mixture, or a part of the mixture, may be performed in a homogenizer, a colloidal mill, and/or an in-line mixer.

Step (c) consists of drying the mixture to create the dried egg product. The dried egg product can be in the form of a powder, pellets, and/or granules. The dried egg product is ultimately used for any appropriate desired purpose. If the liquid egg is inedible liquid egg, the resulting dried egg product is dried inedible egg product which may be used, for example, as animal feed. If the liquid egg is edible liquid egg, the resulting dried egg product is dried edible egg product which may be used, for example, in foods for human consumption or in animal feed.

The dried egg product may contain more than 90%, or more than 93% solids. The dried egg product may contain less than 99%, or less than 97% solids. The dried egg product may contain 90% to 99%, or 93% to 97% solids.

The dried egg product may contain more than 35%, or more than 40% proteins. The dried egg product may contain less than 56%, or less than 53% proteins. The dried egg product may contain 35% to 56%, or 40% to 53% proteins.

The dried egg product may contain more than 23%, or more than 33% fats. The dried egg product may contain less than 43%, or less than 50% fats.

The dried egg product may contain more than 1%, or more than 3% ash (% based on total solids). The dried egg product may contain less than 8%, or less than 6% ash (% based on total solids).

The dried egg product may contain more than 1%, or more than 3% moisture. The dried egg product may contain less than 10%, or less than 7% moisture. The dried egg product may contain 1% to 10%, or 3% to 7% moisture.

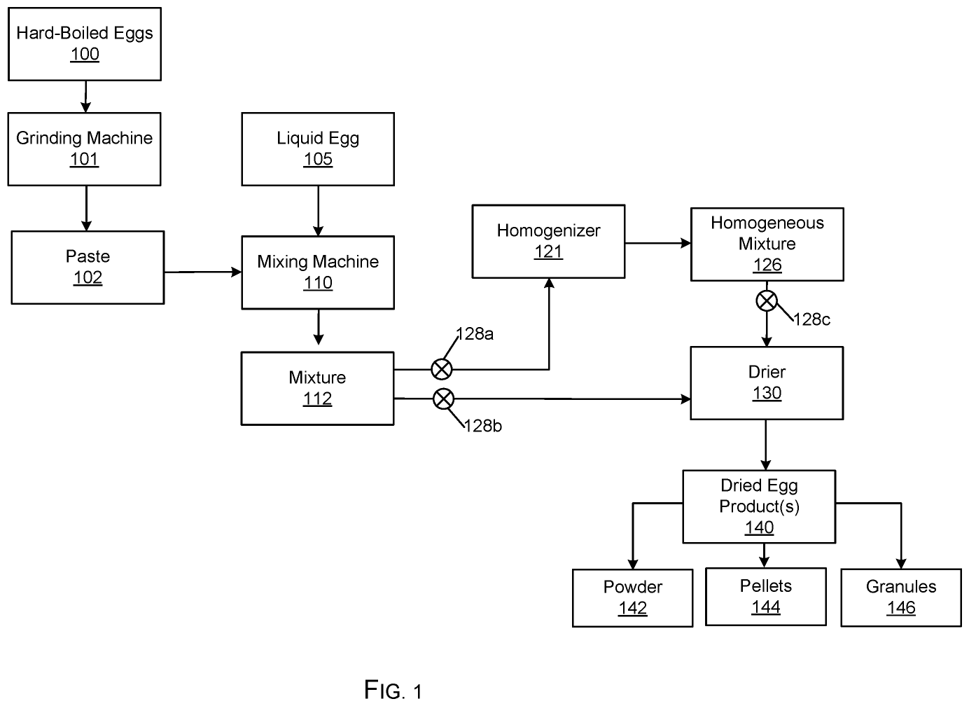

FIG. 1 illustrates an embodiment of a system and method of making dried egg products (i.e., dried inedible egg products or dried edible egg products) from cooked eggs in accordance with the present disclosure. First, an amount of hard-boiled eggs 100 is ground into a paste 102 via a grinding machine 101, such as a grinder or a crusher. The grinding machine 101 will be selected by and understood by those skilled in the art, and may be any appropriate grinding machine whether now existing or later developed.

The paste 102 is then transferred to a mixing machine 110, such as a mix tank mixer, a shear mixer, wherein an amount of liquid egg 105 is added to form a mixture 112. Adding the amount of liquid egg 105 decreases the viscosity of the mixture 112 when compared to the paste 102, which allows for further processing and transportation of the mixture 112. The amount of liquid egg 105 may be obtained from any source as would be understood by those skilled in the art, such as breakers, broilers, or graders.

In some embodiments, the mixture 112 is transported directly to a drier 130, wherein the drier 130 is used to create one or more dried egg products 140, such as a powder 142, pellets 144, and/or granules 146. Advantageously, the mixture 112 may also, or alternately, be transported for additional processing in a homogenizer 121. The homogenizer 121 further combines the amount of hard-boiled eggs without shells 100 with the amount of liquid egg 105 into a homogeneous mixture 126. The homogeneous mixture 126 is then transported to the drier 130 for drying into one or more of the dried egg products 140 such as a powder 142, pellets 144, and/or granules 146. Homogenizing the mixture may help prevent clogs in filters and screens used during the process, such as during drying. If both the mixture 112 and the homogeneous mixture 126 are to be dried, drying may occur either separately (in the same or different dryers) or jointly; and if jointly, it may be desirable to mix the mixture 112 with the homogeneous mixture 126 before drying at the drier 130. It will be appreciated by those skilled in the art that the mixing machine 110, the homogenizer 121, and the drier 130 may vary and be selected based on a number of factors, such as availability, efficiency, production volume, and associated costs.

In some embodiments, one or more pumps 128a, 128b, 128c are used to transport the mixture 112 to the homogenizer 121 and the drier 130, and to transport the homogeneous mixture 126 to the drier 130. The dried egg products 140 are ultimately used for any appropriate desired purpose. If the liquid egg 105 is inedible liquid egg, the resulting dried egg products 140 are dried inedible egg products which may be used, for example, as animal feed. If the liquid egg 105 is edible liquid egg, the resulting dried egg products 140 are dried edible egg products which may be used, for example, in foods for human consumption or in animal feed.

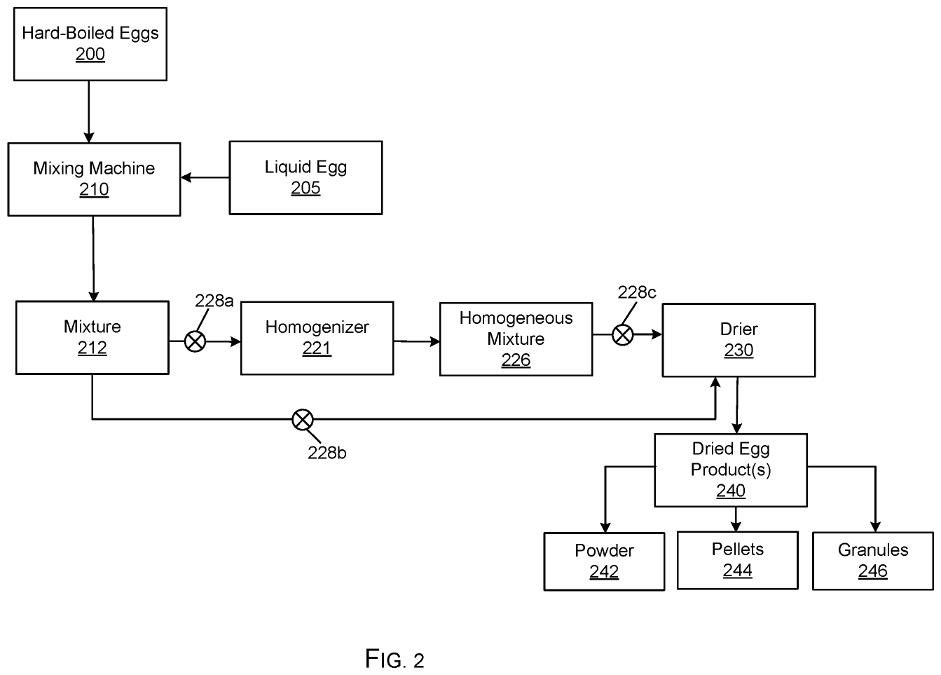

FIG. 2 illustrates another embodiment of a system and method of making dried egg products (i.e., dried inedible egg products or dried edible egg products) from cooked eggs in accordance with the present disclosure. In this embodiment, an amount of hard-boiled eggs 200 is added to a mixing machine 210, such as a mix tank mixer, a shear mixer, or a grinder. To decrease the viscosity and to enable or increase pumpability, liquid egg 205 is added to the mixing machine 210. The resulting mixture 212 is able to travel through the process. Again, the amount of liquid egg 205 may be obtained from breakers, broilers, or graders. The mixture 212 may be transported directly to a drier 230 for drying into dried egg products 240, such as a powder 242, pellets 244, and/or granules 246. Advantageously, the mixture 212 may additionally, or alternately, be transported to a homogenizer 221 for further mixing into a homogenous mixture 226, wherein the homogenous mixture 226 is then transported to the drier 230 for drying into the dried egg products 240 such as a powder 242, pellets 244, and/or granules 246.

If both the mixture 212 and the homogeneous mixture 226 are to be dried, drying may occur either separately (in the same or different dryers) or jointly; and if jointly, it may be desirable to mix the mixture 212 with the homogeneous mixture 226 before drying at the drier 230. Transportation of the mixture 212 to the drier 230 and homogenizer 221, and the homogenous mixture 226 to the drier 230, may be achieved via one or more pumps 228a, 228b, 228c. The dried egg products 240 may ultimately be used for any appropriate desired purpose. If the liquid egg 205 is inedible liquid egg, the resulting dried egg products 240 are dried inedible egg products which may be used, for example, as animal feed. If the liquid egg 205 is edible liquid egg, the resulting dried egg products 240 are dried edible egg products which may be used, for example, in foods for human consumption or in animal feed.

Notably, the various embodiments discussed above and below may benefit significantly from not adding water to create the mixture 112, 212, 312, 412, and from not processing the mixture 112, 212, 312, 412 through a filter or membrane for removing water.

Features described above as well as those claimed below may be combined in various ways without departing from the scope hereof. The following examples illustrate some possible, non-limiting combinations:

(A1) A method of making dried egg product utilizing cooked eggs includes the steps of selecting an amount of cooked eggs and an amount of liquid egg, creating a mixture, transporting the mixture, and drying. The mixture includes the amount of cooked eggs and the amount of liquid egg and is less viscous than the amount of cooked eggs. The drying step includes drying at least one item selected from the group consisting of the mixture and a homogeneous mixture created from the mixture to create the dried egg product. The amount of cooked eggs and the amount of liquid egg are selected based on: (a) a desired solid and protein level in the dried egg product; and/or (b) a desired viscosity of the mixture; and/or (c) the amount of ash in the dried egg product. The amount of cooked eggs and the amount of liquid egg make up at least 95% by weight of the mixture.

(A2) For the method denoted as (A1), the amount of cooked eggs and the amount of liquid egg make up at least 98% by weight of the mixture.

(A3) For the method denoted as (A1), the amount of cooked eggs and the amount of liquid egg make up at least 99% by weight of the mixture.

(A4) For the method denoted as (A1), the amount of cooked eggs and the amount of liquid egg make up at least 99.9% by weight of the mixture.

(A5) For the method denoted as (A1), the mixture consists essentially of the amount of cooked eggs and the amount of liquid egg.

(A6) For the method denoted as (A1), the amount of cooked eggs is 10% to 30% by weight of the amount of liquid egg.

(A7) For the method denoted as (A1), the amount of cooked eggs is 10% to 60% by weight of the amount of liquid egg.

(A8) For the method denoted as (A7), a solids content of the amount of cooked eggs is 27% to 33% and a protein content of the amount of cooked eggs is 12% to 18%.

(A9) For the method denoted as (A1), the mixture is not processed through a filter or membrane for removing water.

(A10) For the method denoted as (A1), creating the mixture does not include adding water.

(A11) For the method denoted as (A1), transporting the mixture includes pumping the mixture.

(A12) For any of the methods denoted (A1)-(A11), the liquid egg is inedible liquid egg and the dried egg product is dried inedible egg product.

(A13) For any of the methods denoted (A1)-(A11), the liquid egg is edible liquid egg and the dried egg product is dried edible egg product.

(A14) A method of making dried egg product utilizing cooked eggs includes a mixing step, a drying step, and at least one transporting step. In the mixing step, an amount of cooked eggs is mixed with an amount of liquid egg to create a mixture. In the drying step, at least one item selected from the group consisting of the mixture and a homogeneous mixture created from the mixture are dried to create the dried egg product. In the at least one transporting step, the mixture is transported from the mixing step to the drying step. The mixture is less viscous than the amount of cooked eggs to facilitate transporting from the mixing step to the drying step. The mixture is not processed through a filter or membrane for removing water.

(A15) For the method denoted as (A14), water is not added to the mixture before the mixture is transported to the drying process.

(A16) For the method denoted as (A14), the mixing step utilizes at least one mixing machine selected from the group consisting of a mix tank mixer, a shear mixer, and a grinder.

(A17) For the method denoted as (A14), further including a homogenizing step wherein the mixture is homogenized to create the homogeneous mixture, and wherein the drying step includes drying the homogeneous mixture.

(A18) For the method denoted as (A14), further comprising a griding step wherein the amount of cooked eggs is ground into a paste prior to the mixing step.

(A19) For the method denoted as (A18), the griding step utilizes at least one grinding machine selected from the group consisting of a grinder and a crusher.

(A20) For the method denoted as (A14), the drying step utilizes a drier.

(A21) For the method denoted as (A14), the dried egg product is at least one item selected from the group consisting of a powder, a pellet, and a granule.

(A22) For the method denoted as (A14), the cooked egg is hard-boiled eggs, and further comprising a separating step wherein eggshells are separated from the amount of hard-boiled eggs prior to the mixing step.

(A23) For the method denoted as (A14), further comprising a separating step wherein eggshells are separated from the mixture.

(A24) For the method denoted as (A14), the at least one transporting step includes pumping the mixture.

(A25) For the method denoted as (A14), the amount of cooked eggs is 10% to 30% by weight of the amount of liquid egg.

(A26) For the method denoted as (A14), the amount of cooked eggs is 10% to 60% by weight of the amount of liquid egg.

(A27) For the method denoted as (A26), the cooked egg is hard-boiled eggs, a solids content of the amount of hard-boiled eggs is 27% to 33%, and a protein content of the amount of hard-boiled eggs is 12% to 18%.

(A28) For any of the methods denoted (A14)-(A27), the liquid egg is inedible liquid egg and the dried egg product is dried inedible egg product.

(A29) For any of the methods denoted (A14)-(A27), the liquid egg is edible liquid egg and the dried egg product is dried edible egg product.

(A30) A system implementing the method denoted as (A17), wherein at least one mixing machine selected from the group consisting of a mix tank mixer, a shear mixer, and a grinder performs the mixing step; at least one drier performs the drying step; and at least one secondary mixing machine selected from the group consisting of a homogenizer, a colloidal mill, and an inline mixer performs the homogenizing step.

(A31) A system implementing the method denoted as (A18), wherein at least one mixing machine selected from the group consisting of a mix tank mixer, a shear mixer, and a grinder performs the mixing step; at least one drier performs the drying step; and at least one grinding machine selected from the group consisting of a grinder and a crusher performs the grinding step.

(A32) A system implementing any of the methods denoted (A14)-(A29), wherein at least one mixing machine selected from the group consisting of a mix tank mixer, a shear mixer, and a grinder performs the mixing step; and at least one drier performs the drying step.

(A33) For the system denoted as (A32), at least one pump is utilized in the at least one transporting step.

(A34) For any of the methods denoted (A1)-(A5), the amount of cooked eggs is 10% to 30% by weight of the amount of liquid egg.

(A35) For any of the methods denoted (A1)-(A5), the amount of cooked eggs is 10% to 60% by weight of the amount of liquid egg.

(A36) For any of the methods denoted (A1)-(A5) or (A34) or (A35), the cooked egg is hard-boiled eggs, a solids content of the amount of hard-boiled eggs is 27% to 33%, and a protein content of the amount of hard-boiled eggs is 12% to 18%.

(A37) For any of the methods denoted (A1)-(A5) or (A34)-(A36), the mixture is not processed through a filter or membrane for removing water.

(A38) For any of the methods denoted (A1)-(A5) or (A34)-(A37), creating the mixture does not include adding water.

(A39) For any of the methods denoted (A1)-(A5) or (A34)-(A38), transporting the mixture includes pumping the mixture.

(A40) For any of the methods denoted (A14)-(A23), the at least one transporting step includes pumping the mixture.

(A41) For any of the methods denoted (A14)-(A23) or (A40), the amount of cooked eggs is 10% to 30% by weight of the amount of liquid egg.

(A42) For any of the methods denoted (A14)-(A23) or (A40), the amount of cooked eggs is 10% to 60% by weight of the amount of liquid egg.

(A43) For any of the methods denoted (A14)-(A23) or (A40)-(A42), the cooked egg is hard-boiled eggs, a solids content of the amount of hard-boiled eggs is 27% to 33%, and a protein content of the amount of hard-boiled eggs is 12% to 18%.

(A44) For any of the methods denoted (A34)-(A43), the liquid egg is inedible liquid egg and the dried egg product is dried inedible egg product.

(A45) For any of the methods denoted (A34)-(A43), the liquid egg is edible liquid egg and the dried egg product is dried edible egg product.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure. It will be understood that certain features and subcombinations are of utility and may be employed without reference to other features and subcombinations. Not all steps listed in the various figures need be carried out in the specific order described.

### Examples

The following example is provided to illustrate the present invention but is not intended to be limiting.

Three batches of dried egg product were prepared using hard-boiled egg and liquid egg.

The first one was prepared by mixing 79% of liquid egg and 21% of hard-boiled egg. The mixture was then homogenized and dried in order to create a powder having 48.46% proteins, 40.19% fat, 5.93% moisture, and 4.24% ash.

The second one was prepared by mixing 81% of liquid egg and 19% of hard-boiled egg. The mixture was then homogenized and dried in order to create a powder having 48.46% protein, 40.14% fat, 5.54% moisture, and 4.18% ash.

The third one was prepared by mixing 85% of liquid egg and 15% of hard-boiled egg. The mixture was then homogenized and dried in order to create a powder having 47.78% protein, 40.55% fat, 5.74% moisture, and 4.86% ash.

In comparison, a powder made using liquid egg alone averaged 48.28% protein, 40.69% fat, 5.41% moisture, and 4.63% ash.

For all the aforementioned finished product examples, each met the requisite specifications, qualifying them as compliant with the standards for inedible spray-dried egg products.

1. A method of making dried egg product utilizing cooked eggs, comprising:
selecting an amount of cooked eggs and an amount of liquid egg;
creating a mixture comprising the amount of cooked eggs and the amount of liquid egg, the mixture being less viscous than the amount of cooked eggs;
transporting the mixture; and
drying at least one item selected from the group consisting of the mixture and a homogeneous mixture created from the mixture to create the dried egg product;
wherein the amount of cooked eggs and the amount of liquid egg are selected based on: (a) a desired solid and protein level in the dried egg product; and/or (b) a desired viscosity of the mixture; and/or (c) the amount of ash in the dried egg product; and
wherein the amount of cooked eggs and the amount of liquid egg make up at least 95% by weight of the mixture.

2. The method of claim 1, wherein the amount of cooked eggs and the amount of liquid egg make up at least 98% by weight of the mixture.

3. The method of claim 1, wherein the amount of cooked eggs and the amount of liquid egg make up at least 99% by weight of the mixture.

4. The method of claim 1, wherein the amount of cooked eggs and the amount of liquid egg make up at least 99.9% by weight of the mixture.

5. The method of claim 1, wherein the mixture consists essentially of the amount of cooked eggs and the amount of liquid egg.

6. The method of claim 1, wherein the amount of cooked eggs is 10% to 60% by weight of the amount of liquid egg.

7. The method of claim 6, wherein the amount of cooked eggs is 10% to 30% by weight of the amount of liquid egg.

8. The method of claim 1, wherein:
a solids content of the dried egg product is between about 90% and 99%; and
a protein content of the dried egg product is between about 35% and 56%.

9. The method of claim 1, wherein the mixture is not processed through a filter or membrane for removing water.

10. The method of claim 1, wherein creating the mixture does not include adding water.

11. A method of making dried egg product utilizing cooked eggs, comprising:
a mixing step wherein an amount of cooked eggs is mixed with an amount of liquid egg to create a mixture;
a drying step wherein at least one item selected from the group consisting of the mixture and a homogeneous mixture created from the mixture are dried to create the dried egg product; and
at least one transporting step wherein the mixture is transported from the mixing step to the drying step, the mixture being less viscous than the amount of cooked eggs to facilitate transporting from the mixing step to the drying step;
wherein the mixture is not processed through a filter or membrane for removing water.

12. The method of claim 11, wherein water is not added to the mixture before the mixture is transported to the drying process.

13. The method of claim 11, wherein the mixing step utilizes at least one mixing machine selected from the group consisting of a mix tank mixer, a shear mixer, and a grinder.

14. The method of claim 11, further comprising a homogenizing step wherein the mixture is homogenized to create the homogeneous mixture, and wherein the drying step includes drying the homogeneous mixture.

15. The method of claim 11, further comprising a griding step wherein the amount of cooked eggs is ground into a paste prior to the mixing step.

16. The method of claim 11, wherein the dried egg product is at least one item selected from the group consisting of a powder, a pellet, and a granule.

17. A method for making dried egg product utilizing cooked eggs, comprising:
selecting an amount of cooked eggs and an amount of liquid egg;
creating a mixture comprising the amount of cooked eggs and the amount of liquid eggs; and
drying the mixture to create the dried egg product.

18. The method of claim 17, wherein:
the amount of liquid egg is selected from the list consisting of egg yolk, egg white, and a combination thereof; and
the amount of cooked eggs comprises hard-boiled eggs, the amount of cooked eggs comprising from 0 to 20 wt % of shell.

19. The method of claim 17, wherein the method does not include adding water.

20. The method of claim 17, wherein the dried egg product comprises at least about 90% solids and between about 35 and 56% proteins.
